(19) United States
(12) Patent Application Publication
(10) Pub. No.: US 2005/0048962 A1
(43) Pub. Date: Mar. 3, 2005

(54) Communications point-of-presence

(76) Inventors: Watson Wan, Palo Alto, CA (US); Robert M. Chow, Hillsborough, CA (US)

Correspondence Address: Gerald L. Robertson;Sympel Communications, Suite 204, 300 Brannan Street, San Francisco, CA, 94107, US

(21) Appl. No.: 10/654,303

(22) Filed: Sep. 2, 2003

(51) Int. Cl. H04Q 7/20

(52) U.S. Cl. 455/422.1; 455/403

(57) ABSTRACT

A point-of-presence, or “POP”, comprising a pair of wireless radios each having its own antenna, an ethernet switch and a router all powered through an uninterruptable power supply, or “UPS” Said POP being in communication with a network backbone. When used in pairs, with Open Short Path First protocol and said radios being enabled to use dynamic load balancing, said pair of POPs providing a redundant wireless network with extremely small footprint.

### STATEMENT REGARDING FEDERALLY-SPONSORED RESEARCH AND DEVELOPMENT

The present invention has not been developed as a result of any federally funded project, contract or any other situation in which governmental involvement including money, employees, contractors or other support has existed or continues.

### FIELD OF THE INVENTION

The present invention deals with telecommunications technology; specifically, the design and manufacture of “point of presence” network nodes for transmission and reception of video, data and voice communications.

### BACKGROUND OF THE INVENTION

Most major telecommunication service provider's and reseller's Point of Presence” or POP designs employ network elements or equipment which are housed in a dedicated room, in a central office environment, or directly in a data center.

The reason for such location is that the environment provides security, seismic protection, environmental protection including controlled temperature, fire protection and uninterrupted power sourcing.

Traditionally, these providers rely upon their POPs to support thousands of customers. Because so many customers' service is dependant upon these individual POPs, it is imperative that the above security and support measures are available to maintain availability and reliability of the POP.

Attendant to these security measures are other requirements; e.g., area (footprint) to house large uninterruptable power supplies (“UPS”), air conditioning, battery backup power, fire suppression and security against theft. Such logistical requirements demand a certain amount of “footprint” for the integration of these requirements. This footprint dictates the use of a “phone room”, data center or central office.

As a result of these requirements, POP sites must be built in locations having the aforementioned logistical support and dimensional footprint, and the minimal space for rent is generally 10 feet by 10 feet.

In the case of a phone company central office, the cost to prepare a space with all the logistical requirements can cost up to $60,000. On top of the preparation charge, at the low end of the spectrum, $25,000 is needed in the form of equipment with which to function as a network POP. The more customers to be served, the higher the cost of the equipment.

In the case of a privately owned data center, similar preparation costs can amount to $30,000 or more. To rent the rack space necessary for a space will cost a monthly charge of typically $500 per month per rack with surcharges for higher alternating current (“AC”) power rating and direct current (“DC”) power.

In the case of a dedicated room for use as a POP, similar setup costs apply, but on a smaller scale. In a mobile cellular environment this type of POP is termed a “base station.” In the telecom industry, this can also be called, along with the central office location and the data center, a “distribution node.” The dedicated room typically serves a smaller number of customers than the data center or central office and the associated cost is proportional based on that lower number of customers served. In this scenario, the setup costs might be more in range of a room air conditioner, portable fire protection, an alarm system, small battery backup and portable UPS. The anticipated cost of such a traditional POP would be approximately $15,000 for preparation and equipment with the overall ability to serve customers in the range of 500.

Common to these POP configurations as previously stated are the various logistic requirements. Therefore, these types of POPs are limited in that they may only be sited where space and support are available.

What is needed is a POP design which may be located more remotely in order to serve customers where such space and logistical support are not readily available.

As described above, the time needed to prepare the central office POP or data center POP can amount to weeks or months. In the case of a dedicated space POP, days or weeks can be required in order to run power, source equipment, locate and build racks and equipment and then “turn up” or provision the POP. With such limitations, the roll out of a network can take many weeks or months in order to be ready to serve customers.

What is needed is a POP design which can be erected quickly, avoiding the lead times typically necessary today.

Further, the cost of the aforementioned POP designs results in a reluctance by major service providers to establishing POPs in areas where only a relatively small number of customers may be located; i.e., for 200 or 300 customers. What is needed is a POP design which will be of a cost that facilitates installation in areas of small customer population, thereby establishing service in more remote areas.

### SUMMARY OF THE MENTION

It is an object of the present invention to provide a “closet” POP without the footprint requirements of a traditional central office, data center or designated room POP. This is accomplished by providing significantly scaled down components to serve fewer customers, where the impact of temporary periods of unavailability may be either inconsequential in comparison to traditional POPs or compensated by redundancy of neighboring closet POPs.

By serving a smaller number of customers with a closet POP, the need for security to assure continuous availability is reduced. Since the closet POP is designed to serve only approximately 200 customers, if the POP experiences downtime, a large customer base is not affected. In the preferred embodiment of applicant's invention, redundancy of neighboring closet POPs can pick up service for customers whose POP is temporarily down, thereby sharing the load which is not being handled by the inactive or “down” POP. With a network design which includes multiple POPs according to applicant's design, not only the amount and size of equipment is reduced, but other logistical requirements may be unnecessary, thereby significantly reducing the amount of dedicated space and associated logistical requirements needed to serve a customer base.

It is a further object of the present invention to avoid the need for highly regulated temperature in the POP design. Once again, by serving a smaller customer base, the amount of equipment required therefore is drastically reduced. In the traditional POPs, thousands of customers may be served, meaning that large amounts of equipment which generate a large amount of heat and which demand significant amounts of amperage in order to perform are required. These temperature and power requirements result in an environment where in the absence of temperature control, the room or area would continually heat up due to the amount of heat generated by the equipment, and heat is an enemy of electronics.

Applicant's invention, by utilizing a smaller amount of network equipment, requires only a small amount of ventilation, obviating the need for expensive air conditioning and the associated space in which attendant equipment would be housed.

It is a further object of applicant's invention to provide a POP design which does not require expensive, heavy batteries for backup power supply if alternating current (“AC”) is lost. Applicant's design provides for the pickup of customers from a down POP in certain cases, which eliminates the need for continuous operation at all times of the closet POP. In addition, since only a small number of customers are left without service if a POP is down, the significance of the event is far less than if the POP were serving thousands of customers. Consequently, even in cases where no neighboring POP can pick up the inactive POP's customers, the interruption in service from a commercial marketing or operating standpoint is not catastrophic. That is not to say that a service provider would not be concerned with solving the power problem as quickly as possible, but in the end, only a small number of customers would be without service until power can be restored. Further, if power is down at the closet POP, it is highly likely that the probable cause of the loss of power resides with the utility company and the local customer base served by the down POP would not be able to use its equipment either. It is only in the more unlikely case where a power failure is experienced right at the location of the POP, and not the surrounding area, which would result in the served customer base experiencing an interruption in service. With these operational considerations and the statistically small likelihood that customers would see an interruption in service or not be picked up by a neighboring POP, the need for battery backup is eliminated.

It is a further object of the present invention to provide a POP which does not need the footprint for or logistical requirement of fire suppression. Similarly to that of the requirement of air conditioning, in applicant's POP, the need for fire suppression equipment is eliminated. With such a smaller amount of equipment than that of traditional POPs, the amount of power required and heat generated is negligible in comparison to traditional POPs, and fire suppression is therefore not an issue. That is not to say that heat does not get generated in applicant's invention; but the fire prevention necessary in applicant's design is provided by a fireproof enclosure, fire retardant materials in proximity to equipment, and adequate ventilation to avoid the buildup of heat.

In summary, applicant's POP design comprises paired POP sites with very small footprints (for example, 2 feet by 2 feet) that can technically fit in a closet or hand on the external wall of a building in a fireproof metal box or enclosure. The POP is designed to provide support in load balancing between users as well as redundancy. A single POP can support up to 200 users and has a low cost associated with it.

Applicant's POP can provide network access in remote areas for up to 10 miles and for approximately 2 miles in metropolitan areas, due to the need for line-of-site therebetween.

By pairing POPs, a single network device failure will not significantly impact network performance. Users disconnected due to a single network equipment failure can fall back to a redundant POP from milliseconds (router failure) to a few minutes (wireless equipment failure). What results is a network design which provides load balancing and redundancy for wireless network users. Data which can be transmitted in such a fashion includes data, voice and video transmission.

Applicant's POP typically includes a pair of wireless radios but may accommodate up to four radios (2.4 Ghz or 5.x Ghz in the preferred embodiment) in communication with an ethernet switch. 2.4 Ghz radios are typically divided into 11 channels. In order to avoid interference between radios in the same POP, channels will be pre-selected. In one example, the primary radio unit may operate channels 1 and 7, while the secondary unit may operate channels 5 and 8. The radios will broadcast the same extended service set ID, or ESSID, allowing subscrier units to randomly pick a wireless radio which offers the strongest link. Therefore, upon the failure of one radio, the subscriber unit will have the choice to pick up frequency from a different radio. In this way, potential downtime is minimized. In order to achieve this type of redundancy, the “roaming” feature of the radio must be enabled, which allows the subscriber unit to search for an alternative radio in its frequency path.

The ethernet switch is managed by a router with power provided by local utility service through a small un-interruptable power supply. The routers are linked either by wireless or fixed wire link to core routers and switches howsed in a traditional data center, providing the ultimate link to base network servers.

In order to enhance network security and dynamically allocate Internet Protocol addresses to subscribers or users is “PPoE” or Point-to-Point over Ethernet protocol. PPoE is a network dialup protocol similar to traditional modem dialup service except that it is dial on ethernet. Each user is required to login with a name and password to gain authorization to use the network. The login name and password may be encrypted during the authentication process. If at any time the user is disconnected due to a router failure and loses his IP address, the user's equipment will automatically associate with another radio to connect back to the network.

This re-entry is possible by the use of “OPSF” or Open Shortest Path First, a layer 3 routing protocol which allows routers to dynamically route IP networks to the core routers. In applicant's network design, OSPF features including variable length subnet mask, equal cost load balancing and dynamic routing are utilized. Of significance in applicant's design is equal cost load balancing, which supports the redundancy of the wireless network. Each OSPF link can be assigned a “cost”: for example, 10 Mbps may be assigned a cost of 100, and 100 Mbps may be assigned a cost of 10; T1 speed can be assigned a cost of 30 and T3 speed a cost of 20. Such cost assignments allows two separate units (primary and secondary) to load balance all network traffic by seeking the shortest open path, as defined by “cost.”

Areas may also be used to define network segments in a network employing OSPF routing. Typically, Area “0” is defined as the core network with all over Areas required to connect to each other through Area “0”. In one embodiment of applicant's invention, each pair of POPs may constitute an Area.

### BRIEF DESCRIPTION OF THE DRAWINGS

FIG. 1 is a schematic overview of the physical layout of a closet pop also showing the realtionship between the data center, the closet pops and a subscriber or user.

FIG. 2 is a diagrammatic representation of equal cost load balancing in ospf routing, showing the relationship of area “0” backbone routers and three other areas comprised of closet pop pairs.

### DETAILED DESCRIPTION OF THE INVENTION

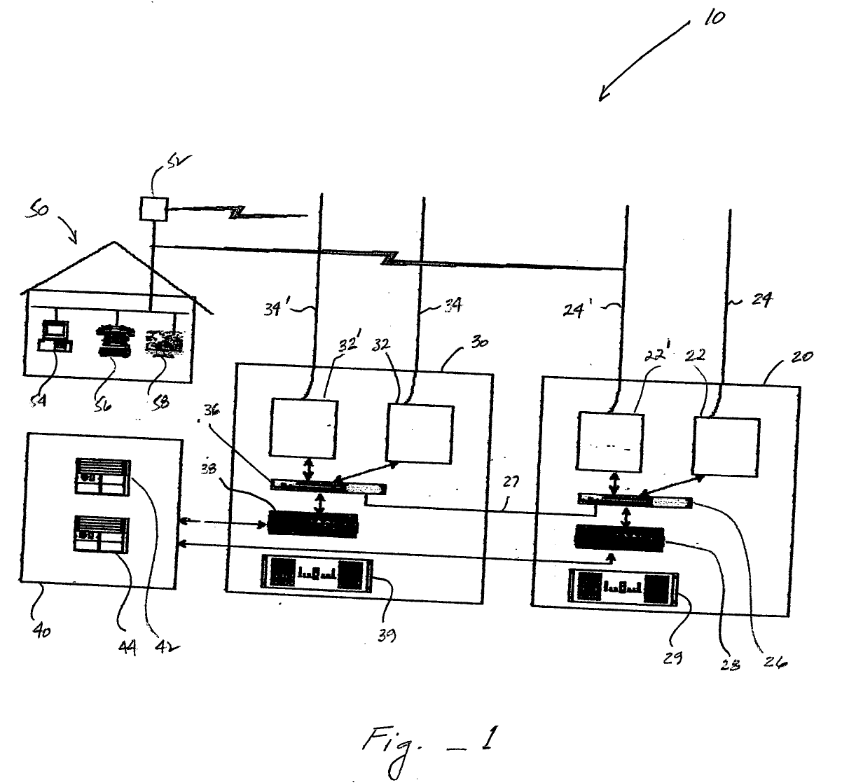

As seen in FIG. 1, a network 10 is comprised of two POPs, 20 and 30, a data center 40 and a subscriber's data system 50. Each POP has two wireless radios, 22, 22′, 32 and 32′, each radio in communication with antennae 24, 24′, 34 and 34′. In the preferred embodiment, wireless radios 22, 22′, 32, and 32′ are typically Airpoint Pro Outdoor radios, model SB2510 or equivalent. Also in the preferred embodiment, antennae 24, 24′, 34 and 34′ are typically a 360 degree HyperGain model 2415U. All antenna and all radios are linked with LMR 400 model external antenna cable. FIG. 1 shows 2 such antennas for each POP. It is possible to utilize a single antenna to broadcast from the two radios as long as differing channels are used by each radio.

Radios 22 and 22′ are each in communication via ethernet cable with ethernet switch 26. Radios 32 and 32′ are likewise in communication via ethernet cable with ethernet switch 36. In the preferred embodiment, switches 26 and 36 are typically generic 4 port or 8 port 10/100 ethernet switches. Ethernet switches 26 and 36 are likewise linked to one another via connection 27.

As ethernet switch 26 is in communication via ethernet cable with a router 28, switch 36 is likewise in communication with router 38. In the preferred embodiment, each router is typically a Cisco model 1720 or equivalent.

Alternating current or “AC” power is supplied to each POP via uninterruptable power supplies (“UPSs”) 29 and 39. In the preferred embodiment, an APC BackUPS ES Series UPS is utilized.

In data center 40, network equipment is housed; in particular, core routers/switches 42 and 42 are housed therein. Router/switch 42 communicates with router 38 in POP 30 via typically a T1 or fractional T3 connection. Likewise, router/switch 44 communicates with router 28 also via typically a T1 or fractional T3 connection.

System 50, belonging to a network user, is provided with antenna/radio 52, typically a Smartbridge Outdoor unit, which is in communication via ethernet cable with the user's computer 54, his or her telephone system 56 or a television/video apparatus 58. Antenna 52 is provided its primary link to data center 40's core routers/switches via antenna 34′ of POP 30. In the event POP 30 is inactive for any reason, by virtue of the equal cost load balancing feature of OSPF protocol, allows antenna 52 to utilize as a fallback link, antenna 24′ of POP 20.

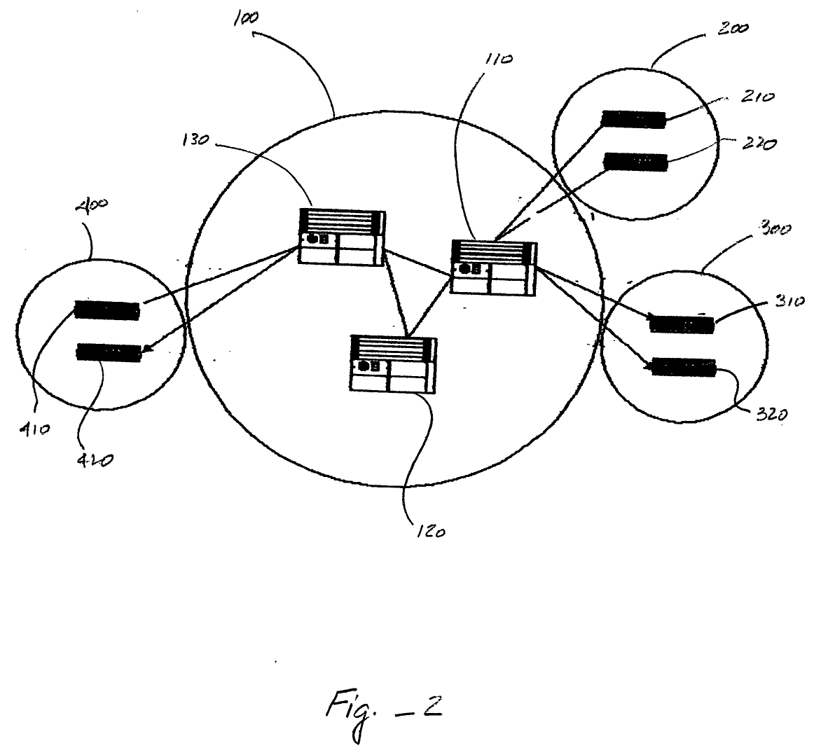

In FIG. 2, the relationship between OSPF Areas is shown. Area “0” is shown as area 100, housing several backbone routers 110, 120 and 130. POP 200, containing routers 210 and 220 are each in communication with backbone router 110. Likewise, POP 300, having routers 310 and 320 are each in communication with backbone router 110. POP 400 with routers 410 and 420 are in communication with backbone router 130 of Area “0”. As each POP may be assigned an area designation, POP 200 could be Area “1”, POP 300 could be Area “2” and POP 400 could be Area “3”. Each Area still must go through Area “0” to get to the backbone of the network. In an OSPF environment, if a cost of 100 is assigned to each connection between the Areas and the backbone routers, and the communication between the backbone routers themselves is, for example, assigned a cost of 10, then the load balancing is accomplished. The dynamic load balancing will continue to share load consistent with the cost assignments. OSPF runs link-state protocol that consumes less bandwidth than traditional RIPv1 and RIPv2 protocols. With the dynamic routing feature of the routers enabled, and with the equal cost load balancing feature utilized, configuration time is reduced and the scalability of the IP network is enhanced.

The manner of physically interconnecting the various components described herein comprise the linking of said components using ethernet cabling and the like are well known in the industry and are not detailed in the foregoing specification. The subject of applicant's invention involves the integration of these components in a manner which creates a POP of small footprint with the redundancy, dynamic routing and OPSF capabilities heretofore described.

While the invention has been described in connection with what is presently considered the most practical and preferred embodiment(s), it is to be understood that the invention is not limited to the disclosed embodiment(s) but, on the contrary is intended to cover various modifications and equivalent arrangements included within the scope of the appended claims.

1. A point-of-presence comprising:
primary and secondary wireless radios;
an ethernet switch in communication with said primary and secondary radios;
a router in communication with said ethernet switch;
a primary power supply;
an uninterruptable power supply, or UPS, connected to said primary power supply, said UPS providing power to said radios, said ethernet switch and said router;
a network having at least one backbone router, said network being in a location away from said point-of-presence;
communication link between said router and said network, providing communication between said backbone router and said point-of-presence router;
at least one antenna in communication with said primary and secondary wireless radios, said antenna providing the basic link to said network for a subscriber having IP access to said network and means for transceiving data thereto.
